(19) United States
(12) Patent Application Publication
(10) Pub. No.: US 2013/0275287 A1
(43) Pub. Date: Oct. 17, 2013

(54) BINARY OPTION STRUCTURE WITH PERFORMANCE RANKING WITHOUT MARKET MAKER

(71) Applicant: Yochai GRAETZ, Tel Aviv (IL)

(72) Inventor: Yochai GRAETZ, Tel Aviv (IL)

(73) Assignee: FINANEX LTD., Road Town (VG)

(21) Appl. No.: 13/492,941

(22) Filed: Jun. 11, 2012

Related U.S. Application Data
(63) Continuation of application No. PCT/IB2011/050773, filed on Feb. 24, 2011.
(60) Provisional application No. 61/309,443, filed on Mar. 2, 2010.

(51) Int. Cl. G06Q 40/06

(52) U.S. Cl. CPC G06Q 40/06
USPC 705/37

(57) ABSTRACT

In a binary option structure, trades of buyers do not having counterpart trades of a market maker. Instead, for each order in a series, a digital processor assigns a zero value to orders whose barrier was not hit and for buyers whose barrier was hit calculates a distance between an entry price and the barrier, the digital processor ranking the distances of buyers associated with each order in the series. Upon expiration of the touch option, the digital processor divides the ranking into a winning part and a losing part and calculates payouts to buyers in the winning part by dividing the total investment series, less any commissions, among buyers in the winning part of the ranking. A display structure seen by participants shows current ranking. In response, buyers can move their barrier after placing the order, provided the barrier was not been hit, and without crossing the entry price.

### FIELD AND BACKGROUND OF THE INVENTION

The present invention relates to systems and methods for binary options trading for securities and, more particularly to a binary options structure that ranks performance without a market maker.

Binary options generally fall into the categories of American binary options (touch options) and European binary options. Touch options, also known as hit options, are a type of exotic option that gives the buyer a payout once the price of the underlying asset reaches or surpasses a predetermined price level. This price level is called the barrier or touch-level. The touch option pays a fixed amount if the underlying price ever trades at or beyond the barrier and zero if it does not. The basic One-touch option, also known as American single binary option, consists of one barrier. It is useful for investors who believe that the underlying price of the stock or other security will reach a certain price level before expiration, but are not sure that this price level is sustainable until expiration. The one-touch option can serve such investors better then plain vanilla options (i.e. can generate for them higher returns due to higher payout to premium ratio). The buyer will set the time to expiration, the barrier, and the payout received once this barrier is touched or broken. If the barrier was not reached, the buyer gets no payout and the loss is the premium paid to the seller.

A no-touch option is the opposite of the one-touch option, so the buyer will get the payout if the underlying price will not reach the barrier by the time of expiration.

A double one-touch option, also known as an American double binary option, is a variation that utilizes two barriers (high barrier and low barrier), set by the buyer. This option gives the buyer an agreed upon payout if the price of the underlying asset reaches or surpasses one of two predetermined barrier levels. If neither barrier level is reached prior to expiration, the buyer gets no payout and the loss is the premium paid to the seller. This premium will be higher than the premium paid for an otherwise equal one-touch option, since the probability that the payout will materialize when the buyer sets two barriers is higher. This type of option is useful for investors who believe the price of an underlying asset will undergo a large price movement, but are unsure of the direction of this price movement.

Another variation is the double no-touch option, which is the opposite of the double one-touch option described above. Investors who believe the price of the underlying security will remain bound within a range for a given period of time will buy the double no-touch option. It gives the buyer an agreed upon payout if the price of the underlying asset does not reach or surpass one of two predetermined barrier levels. If one of the barriers was reached before expiration, the buyer will not receive the payout and his or her loss is the premium paid to the seller for this option.

Because these customized options are exotic, there is restricted liquidity for them and they are not listed as standardized products on a formal exchange, but rather traded OTC (over the counter). An investor who customizes the touch option specifications by setting a particular barrier, a particular payout and a particular time of expiration cannot always, and in fact usually cannot, expect to find a counterpart willing to take the exact opposite bet at the same moment. As a result, market makers, such as investment banks' trading desks and OTC options dealers, assume the counterpart position and charge compensation for this.

The problem with these touch options is that the price the buyer pays for them (the premium) is usually much higher than the option theoretical value. The theoretical value of a one-touch option is equal to the expectation, under the risk neutral measure, of its discounted is payout (i.e. the risk neutral probability of the payout discounted at the risk free rate). However, the premium the buyer actually pays is inflated because the market maker charges him or her for the service of creating liquidity.

The option price, quoted as a percentage of the payout, is the sum of the theoretical value, the seller's over hedge costs, which reflects the option seller's cost of managing his exposure and an additional margin for the seller.

One-touch options with low theoretical value, for instance, can be twice as expensive, and sometimes even more, than their theoretical value due to over hedge costs (See The Market Price of One-touch Options in Foreign Exchange Markets, Dr Uwe Wystup—FX Product Development Commerzbank Securities).

The discontinuity of touch option payout (fixed amount or zero), as opposed to plain vanilla option, greatly complicates its hedging because of the barrier pin risk—the payout jump from nothing below the barrier to everything at or above the barrier (upside barrier). The fact that this touch option can expire at any moment (i.e. its American style) makes the hedging even more complicated.

Assuming negligible interest rates, the seller of a touch option needs to hedge the following exposures: delta (option price sensitivity to a change in the underlying price), gamma (delta sensitivity to a change in the underlying price) and vega (option price sensitivity to a change in the underlying volatility). As the underlying price gets closer to the harrier and the time to expiration shortens, these sensitivities (these Greeks) peak since the stakes are higher: a slight change in the underlying price can breach the bather and reward the buyer with the payout, which otherwise would be zero. The option seller who wishes to hedge the exposure faces several difficulties:

He cannot use static option replication with vanilla options since they falsely assume a Black & Scholes constant volatility, and thus fail to hedge the seller exposure in shifting volatility.

Dynamic hedging of the exposure is associated with very high transaction costs and market structure limitations. When the barrier is hit the seller needs to unwind the deltas used for the hedging. A hedger can face a difference between the price at the barrier and the unwinding price (slippage) due to liquidity holes. Unwinding before hitting the barrier might cost the hedger even more if the barrier will not be hit. Hedging the vega exposure due to underlying price changes and volatility change, is even a bigger challenge since the seller needs to replicate the disappearance of the vega after the barrier. These limitations prevent the seller from structuring a perfect hedge. He would probably be better off by using other barrier options as a partial hedge than using vanilla options. Using continuous payout options in hedging touch options will impose tremendous transaction costs on the hedger. It is necessary to avoid hedging a discontinuous exposure with a continuous one (See Nassim T. (1997), Dynamic Hedging: Managing Vanilla and Exotic Options, Wiley).

Accordingly, the high hedging costs and the market risk the seller takes are reflected in the option price. The overpricing of OTC options, especially those it is difficult to hedge, is particularly true in the case of small and mid-size investors. Such investors do not usually get a direct option quote from the relevant market maker, but even if they do, they will probably overpay for it. If the exposure does not, accidently, coincide with the current exposure on the seller's book, a small amount option, especially if it is short term, will usually generate an overpriced quote. Moreover, most of the small investors still lack access to real time exotic options pricing services, and in any event they are too small to bargain with the market maker or to shop for the best price with several market makers.

There is a compelling need to have a touch options trading system or method that overcomes the drawbacks of the prior art. It would be particularly helpful to have such a system or method that avoids the problem of unfair premiums and other drawbacks of the present system, yet at the same time allows investors to trade actively without liquidity limitations.

### SUMMARY OF THE PRESENT INVENTION

One aspect of the present invention is a method of operating a touch option structure, comprising a digital processor presenting touch option order selections to buyers, the selections including an identity of an underlying security, expiration date and investment amount, the digital processor displaying an entry price representing the underlying security current price, the digital processor storing updated values of the entry price then current for the underlying security until the expiration date; the digital processor recording the buyer's selections and grouping together touch option orders that match in underlying, expiration date and investment amount into a series, the digital processor also receiving a buyer's selection of a barrier for each touch option order in the series and processing the touch option orders of the series; for each order in the series, the digital processor assigning a zero value to orders whose barrier was not hit and for buyers whose barrier was hit calculating a distance between an entry price and the barrier of the order, the digital processor ranking the distances of buyers associated with each order in the series, zero value orders ranked last; the digital processor displaying a regularly updated ranking of the orders in the series, the display available to the buyers and upon expiration of the touch option, the digital processor dividing the ranking into a winning part and a losing part and calculating payouts to buyers in the winning part by dividing an effective total investment series, less any commissions charged, among the buyers in the winning part of the ranking.

A further aspect of the present invention is directed to a method of operating a touch option structure, comprising a digital processor processing trades of buyers for touch options, the trades not having counterpart trades; for each order in a series, the digital processor assigning a zero value to orders whose barrier was not hit and for buyers whose barrier was hit calculating a distance between an entry price and the barrier, the digital processor ranking the distances of buyers associated with each order in the series zero value orders ranked last; and upon expiration of the touch option, the digital processor dividing the ranking into a winning part and a losing part and calculating payouts to buyers in the winning part by dividing an effective total investment series, less any commissions charged, among the buyers in the winning part of the ranking.

A still further aspect of the present invention is directed to a system for binary options, comprising a display structure for displaying an entry price representing the underlying security current price, to prospective buyers, the display structure also including structure for displaying to buyers and prospective buyers an updateable current ranking of the distances associated with orders in a series; and a digital processor programmed to store updated values of the entry price then current for the underlying security until the expiration date, record each buyer's selections of an underlying, an expiration date and an investment amount and group together into a series a plurality of binary option orders that match in underlying, expiration date and investment amount, for each buyer in the series, record the buyer's selection of a barrier for each binary option order in the series and process the binary option orders of the series, for each order in the series, assign a zero value to orders whose barrier was not hit and for buyers whose barrier was hit calculate a distance between an entry price and the barrier of the order with a greater distance associated with a higher rank, the entry price varying with the order and being the entry price at a time that a buyer's order was filled, rank the distances of buyers associated with each order in the series, zero value orders ranked last, and upon expiration of the binary option, divide the ranking into a winning part and a losing part and calculate payouts to buyers in the winning part by dividing an effective investment series, less any commissions charged, among the buyers in the winning part of the ranking. A further aspect of the present invention is directed to a system for double no-touch options, comprising a display structure for displaying an entry price representing the underlying security current price, to prospective buyers, the display structure also including structure for displaying to buyers an updateable current ranking of the distances associated with orders in a series; and a digital processor programmed to store updated values of the entry price then current for the underlying security until the expiration date, record the buyer's selections of the underlying, the expiration date and the investment amount and group together in a series double no-touch option orders that match in underlying, expiration date and investment amount, record a buyer's selection of a high barrier above a buyer's entry price and a low barrier below the buyer's entry price for each double no-touch option order in the series and process the double no-touch option orders of the series, for each order in the series, assign a zero value to orders in which at least one barrier was hit and for buyers whose barriers were not hit calculate a distance between the high barrier and the low barrier, rank the distances of buyers associated with each order in the series wherein the smaller the distance, the higher the rank, zero value orders ranked last, and upon expiration of the double no-touch option, divide the ranking into a winning part and a losing part and calculate payouts to buyers in the winning part by dividing an effective total investment series, less any commissions charged, among the buyers in the winning part of the ranking.

A still further aspect of the present invention is a system for double two-touch options, comprising a display structure for displaying an entry price, which reflects the underlying security current price, to prospective buyers, the display structure also including structure for displaying to buyers and prospective buyers an updateable current ranking of the distances associated with orders in a series; and a digital processor programmed to store updated values of the entry price then current for the underlying security until the expiration date, record the buyer's selections of the underlying, the expiration date and the investment amount and group together in a series double two-touch option orders that match in underlying, expiration date and investment amount, record a buyer's selection of a high barrier above a buyer's entry price and a low barrier below the buyer's entry price for each double two-touch option order in the series and process the double two-touch option orders of the series, for each order in the series, assign a zero value to orders in which at least one barrier was not hit and for buyers whose to barriers were hit calculate a distance between the high barrier and the low barrier, rank the distances of buyers associated with each order in the series wherein the higher the distance, the higher the rank, zero value orders ranked last, and upon expiration of the double two-touch option, divide the ranking into a winning part and a losing part and calculate payouts to buyers in the winning part by dividing an effective total investment series, less any commissions charged, among the buyers in the winning part of the ranking.

A still further aspect of the present invention is a system for no-touch options, comprising a display structure for displaying an entry price, representing the underlying security current price, to prospective buyers, the display structure also including structure for displaying to buyers and prospective buyers an updateable current ranking of the distances associated with orders in a series; and a digital processor programmed to store updated values of the entry price then current for the underlying security until the expiration date, record each buyer's selections of an underlying, an expiration date and an investment amount and group together into a series a plurality of no-touch option orders that match in underlying, expiration date and investment amount, for each buyer in the series, record the buyer's selection of a barrier for each no-touch option order in the series and process the no-touch option orders of the series, for each order in the series, assign a zero value to orders whose barrier was hit and for buyers whose barrier was not hit calculate a distance between an entry price and the barrier of the order with a smaller distance associated a higher rank, the entry price used for calculating the rank capable of varying with the order and being the entry price at a time that a buyer's order is filled, rank the distances of buyers associated with each order in the series, zero value orders ranked last, and upon expiration of the touch option, divide the ranking into a winning part and a losing part and calculate payouts to buyers in the winning part by dividing an effective total investment series, less any commissions charged, among the buyers in the winning part of the ranking.

A further aspect of the present invention is a system of touch options trading in which trades do not have counterpart trades, the system comprising a display structure for displaying an entry price, representing the underlying security current price, to prospective buyers, the display structure also including structure for displaying to buyers and prospective buyers an updateable current ranking of the distances associated with orders in a series; and a digital processor programmed to store updated values of the entry price then current for the underlying security until the expiration date, record the buyer's selections of the underlying, the expiration date and the investment amount and group together touch option orders that match in underlying, expiration date and investment amount into a series, for each touch option order in the series, record a buyer's selection of a barrier and process the touch option orders of the series, for each order in the series, assign a zero value to orders whose barrier was not hit and for buyers whose barrier was hit calculate a distance between an entry price and the barrier of the order, the entry price capable of varying with the order and being the entry price at a time that a buyer's order is filled, rank the distances of buyers associated with each order in the series, zero value orders ranked last, and upon expiration of the touch option, divide the ranking into a winning part and a losing part and calculate payouts to buyers in the winning part by dividing an effective total investment series, less any commissions charged, among the buyers in the winning part of the ranking.

A further aspect of the present invention is a system for European binary options, comprising a display structure for displaying an entry price, which reflects the underlying security current price, to prospective buyers, the display structure also including structure for displaying to buyers an updateable current ranking of the distances associated with orders in a series; and a digital processor programmed to store updated values of the entry price then current for the underlying security until the expiration date, record each buyer's selections of an underlying, an expiration date and an investment amount and group together into a series a plurality of European binary option orders that match in underlying, expiration date and investment amount, for each buyer in the series, record the buyer's selection of a barrier for each European binary option order in the series and process the European binary option orders of the series, for each order in the series, assign a zero value to orders whose barrier was not reached by the closing price at expiration and for buyers whose barrier was reached by the closing price at expiration calculate a distance between an entry price and the barrier of the order with a greater distance associated with a higher rank, the entry price varying with the order and being the entry price at a time that a buyer's order was filled, and upon expiration of the European binary option, rank the distances of buyers associated with each order is the series, zero value orders ranked last, divide the ranking into a winning part and a losing part and calculate payouts to buyers in the winning part by dividing an effective total investment series, less any commissions charged, among the buyers in the winning part of the ranking.

A further aspect of the present invention is a system for European binary options, comprising a display structure for displaying an entry price, representing the underlying security current price, to prospective buyers, the display structure also including structure for displaying to buyers and prospective buyers an updateable current ranking of the distances associated with orders in a series; and a digital processor programmed to store updated values of the entry price then current for the underlying security until the expiration date, record each to buyer's selections of an underlying, an expiration date and an investment amount and group together into a series a plurality of European binary option orders that match in underlying, expiration date and investment amount, for each buyer in the series, record the buyer's selection of a barrier for each European binary option order in the series and process the European binary option orders of the series, for each order in the series, assign a zero value to orders whose barrier was reached by the closing price at expiration and for buyers whose barrier was not reached by the closing price at expiration calculate a distance between an entry price and the barrier of the order with a smaller distance associated a higher rank, the entry price used for calculating the rank capable of varying with the order and being the entry price at a time that a buyer's order is filled, upon expiration of the European binary option, rank the distances of buyers associated with each order in the series, zero value orders ranked last, divide the ranking into a winning part and a losing part and calculate payouts to buyers in the winning part by dividing an effective total investment series, less any commissions charged, among the buyers in the winning part of the ranking.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a graphic illustration of the pricing involved in a One-Touch options trading structure, in accordance with one embodiment of the present invention;

FIG. 2 is a graphic illustration of the pricing involved in a No-Touch options trading structure, in accordance with one embodiment of the present invention;

FIG. 3 is a graphic illustration of the pricing involved in a Double Two-Touch options trading structure, in accordance with one embodiment of the present invention;

FIG. 4 is a graphic illustration of the pricing involved in a Double No-Touch options trading structure, in accordance with a further embodiment of the present invention;

FIG. 5 is a flow chart showing a method in accordance with one embodiment of the present invention; and

FIG. 6 is a flow chart showing a further method in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a touch options structure in which the premium (cost of the option) is pre-defined and equal to all the investors in the series regardless of the barrier level each of them set. The winning investors may be those ranked by a digital processor above a payout line. Accordingly, the winning investors represent a pre-defined fraction or percentage of investors who are entitled to get a payout. The ranking may be based on distance. Except for those investors whose barrier was not hit. (or in the case of no-touch and double no-touch options those whose barrier was bit) who receive a zero value, rank is based on a longer distance between the barrier and the entry price. In the case of no-touch options rank is based on the shorter distance between the barrier and the entry price. In the case of double two-touch options, the rank is based on the longer distance between the two touched barriers. In the case of double no-touch options, rank is based on the shorter distance between the two untouched barriers. A digital processor and a display structure may be used to display the rankings and investors who wish to improve their chances may move the Barrier before the barrier is hit, although not across an entry price. With no-touch options, the investor can change the barrier level only in the opposite direction to the entry (i.e. away from the entry, so that the distance between this barrier and the entry price will increase).

In contrast to prior art touch options, in which given the underlying, the expiration date and the payout, the Distance between the Barrier and the Entry Price dictates the option price (in one-touch option the correlation between the distance and the premium is negative, so the greater the distance, the lower the premium), the present invention dictates a fixed premium regardless of the distance between the Barrier and the Entry Price. In contrast to the prior art touch options in which the Distance is used to set the premium, in the present invention the Distance is used to rank the different buyers of this option. In further contrast to the prior art touch options, in which the investor, particularly the small or medium sized investor, pays a liquidity service fee built into the premium since the premium is significantly more than it would be if it merely reflect the probability of hitting the Barrier, the touch option of the present invention costs the investor a fixed price and the investor pays no service fee for making a market. In contrast to prior art touch options wherein the premium is set invisibly to the buyer, the touch option structure of the present invention may be transparent to the buyer regarding the setting of the option price. In still further contrast to prior art touch option structures, in which once you fill a buyer's order the buyer cannot change the barrier, in the touch option structure of the present invention, the buyer can change the barrier after the order was filled as long as the barrier was not hit and provided the change does not move the barrier across the entry price to the opposite side of the entry price. With no-touch and Double no-touch options the investor can only move the barrier away from the entry price. In further contrast to the prior art, the buyers may make such changes in the barrier after seeing a display of the current rankings. In contrast to prior art touch options wherein setting an additional barrier increases the premium dramatically and is limited to one-touch option (thus creating the double one-touch option with one barrier on each side of the entry price), the investor in any of the touch/no-touch option structures of the present invention may be able to set several additional barriers wherever he wishes for marginal cost; and the barrier that gives the best rank is the one upon which the investor will be ranked.

The principles and operation of a system and method for a touch options structure with performance ranking without a market maker, according to the present invention may be better understood with reference to the drawings and the accompanying description.

The following terms of art used in this patent application are defined as follows:

Expiration—the date and the time in which the option expires.

Investment—the amount, in currency terms, the investor pays for the option.

Series—all the options with the same Underlying, Expiration and Investment.

Total Series Investment (interchangeable with “Total Investment Series”)—the total Investment in all the options in the Series.

Total Series Investment “less any commissions” charged refers to Total Series Investment less commissions if there are any commissions. This should not be understood to necessarily mean that there are any commissions charged. In addition, this should not be taken to mean that some step is necessarily taken in connection with commissions but merely that if there are commissions charged then the Total. Series Investment is reduced by that amount. Typically, a commission would be a fixed commission.

Entry Price—the underlying “market price” at the time the option was bought. It should be clearly understood that the term “entry price” as used in this patent application is not necessarily (although it usually is) the exact underlying current price (i.e. the “Last”) but rather could be the Bid, the Ask, the Mid Price or some other interpolation on the current underlying data. In a preferred embodiment, whatever the Entry Price means (i.e. Bid, Ask, Mid, etc.) at one point (i.e. when the order is filled) is what it continues to mean throughout until expiration.

Barrier—a predetermined price level the investor sets above or under the Entry Price.

Direction—The position of the Barrier relative to the Entry Price (above or below).

Hit—the event in which the underlying price is traded at or beyond the option. Barrier before expiration. The underlying price may in a preferred embodiment be its “Last” price.

Point—the underlying price quotation unit.

Distance—the absolute value of the difference, in Points, between the Barrier and the Entry Price (in the case of double no-touch or double two-touch options, the Distance is the absolute value of the difference, in Points, between the high barrier and the low barrier).

Rank—All the options in the Series are ranked on a scale. The Rank is the position or number of the option on that scale, starting from the option with the highest Distance followed by the options with lower Distance and finally the option with zero value in the end (in the case of no-touch and double no-touch options, the rank starting from the option with the lowest Distance followed by options with higher Distance and finally the zero value options in the end).

Underlying—the underlying asset that the option relates to, such as the identity of the security, e.g. IBM common stock.

Position held time—time interval from when purchase of the option was filled until the Barrier was hit.

Payout line—the line that divides those who receive a payout and those who do not

The present invention may allow investors, especially small and mid-size, to buy touch option structures which are transparent and not overpriced, by eliminating the need of a counterpart, such as market makers, while avoiding liquidity limitations. The new option types presented here may be structured as a multiple investor contest in which the investors with the higher ranked performance in a series of options gain the Investment paid by the investors with the lower ranked performance in that series of options.

Longer Distance One-Touch Option

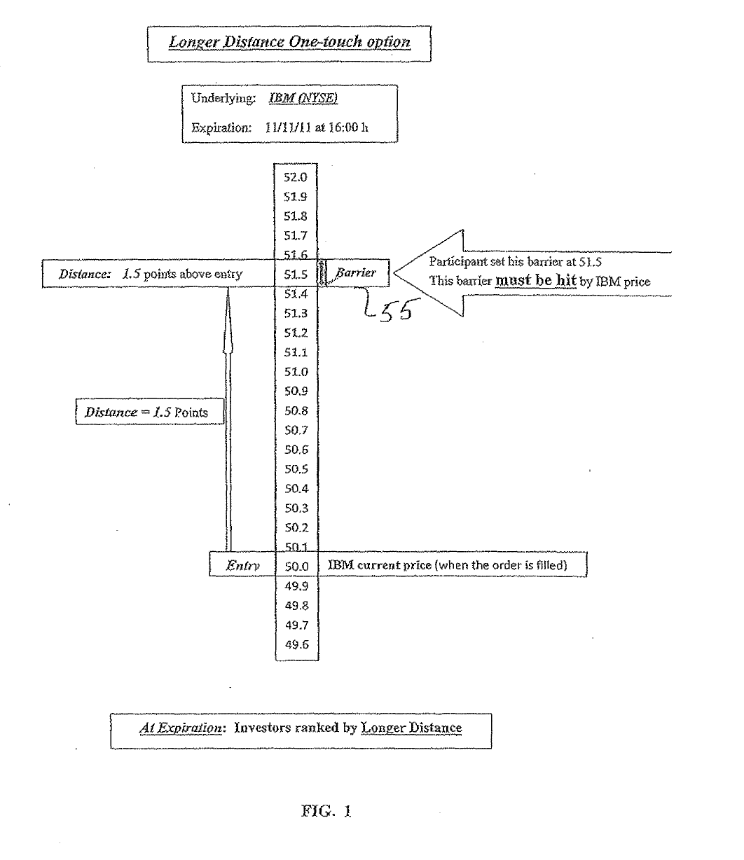

As seen from FIG. 1, this option type is aimed for investor who predicts high volatility of the underlying so it will reach a certain price, although it might not hold at this price level until expiration. A classical use of such option is before news/data release.
1. The trading platform operator presents the investors a list from which he chooses an underlying security/asset, Expiration and Investment for the option.
2. The Investor sets a Barrier that he predicts will generate a high Rank, i.e. the Barrier will be hit and its Distance is relatively high, the investor can set in the initial order more than one Barrier in any Direction (up to a certain number of additional barriers dictated by the platform operator, who may also charge a price for setting additional barriers). For the Rank, the system considers the longest Distance Barrier that was Hit (i.e. the Barrier that will generate the highest rank).
3. The investor may submit his order as a market order or conditional order and the platform will fill the order accordingly. The conditional entry order is placed on the system but will take effect only if the underlying security reached the entry level specified by the investor. Only then the order is considered to be filled and the entry price is this conditional level. If the underlying quote did not reach the conditional entry level the order is void. Accordingly, the Entry Price is the underlying market price (as defined above) at the time the order is filled.
4. As long as the Barrier was not Hit, the investor can change the Barrier position but only within the Barrier's Direction relative to the entry price, i.e. without crossing the Entry Price (up to a certain number of changes dictated by the platform operator). Furthermore, the investor can place a conditional change order, which will automatically move a barrier that was not hit, until a specified time, to another level. This new level can be stated as a number or as the underlying price at that time. The limitation on crossing the entry price still applies.
5. After Expiration, all the options in which a Barrier was Hit are Ranked by their Distance, starting from the highest Distance option and followed with the lowest Distance (if the Barrier was not Hit, the option gets a zero effective value, may be ranked last and may be disqualified for winning). If two options achieved the same rank, a tie breaker will be applied by the following order: i. The Distance in percentage terms from the Entry Price; ii. Position held time (shorter time is better). iii. The time the order was filled (earlier is better).
6. Excluding commission, the Total Series Investment is divided between the investors holding the options Ranked on the upper half of the ranking. Typically, this division is equal, so that in this example each of these investors gets a 100% return on his investment. If less than 50% of the options have a Barrier that was Hit, then the Total Series Investment is divided equally between the investors holding options with a Hit Barrier (i.e. Distance greater than Zero), so the return of each, such investor is higher than 100%. The division of the payout can also be unequal in accordance with a prescribed formula.

Shorter Distance No-Touch Option

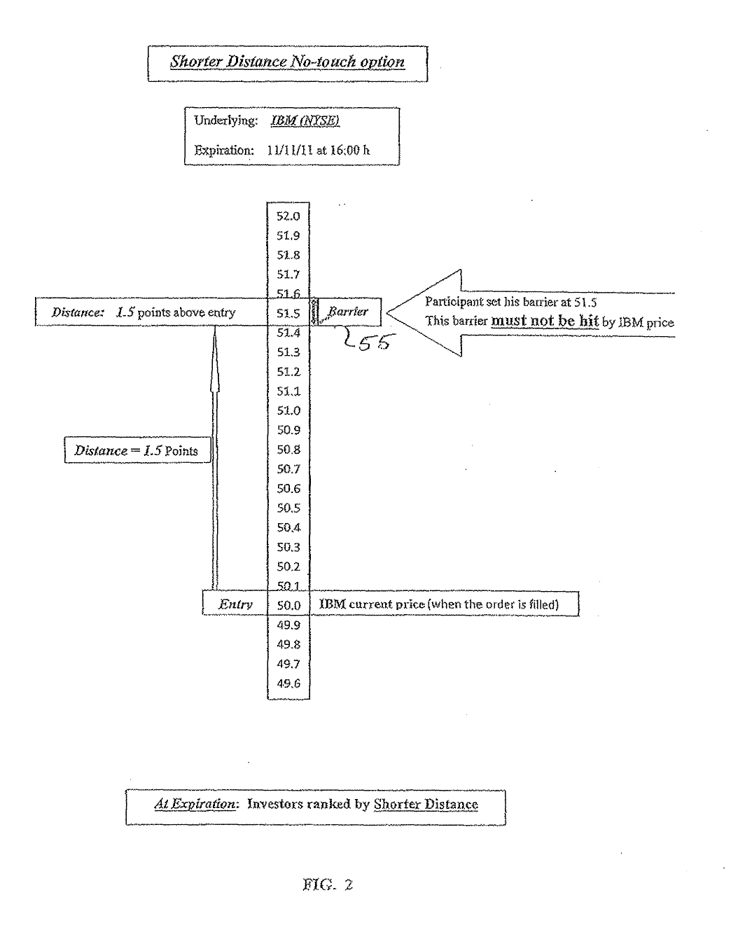

As seen from FIG. 2, a variation of the Longer Distance One-Touch option is the Shorter Distance No-Touch option.

1. The trading platform operator presents the investors a list from which he chooses an underlying, Expiration and Investment for the option.

2. The investor sets a Barrier that he predicts will generate a high Rank, i.e. the Barrier will not be Hit and the Distance is relatively low. Ranking is based on the smallest Distance between the Barrier and the Entry Price and the investor can set in his initial order more than one Barrier in any Direction (up to a certain number of additional barriers dictated by the platform operator). For the Rank, the system considers the smallest Distance Barrier that was not Hit. As long as the Barrier was not Hit, the investor can also change the Barrier position but only move it away from the entry (i.e. increasing the Distance between the Barrier and the Entry).

Shorter Distance Double No-Touch Option

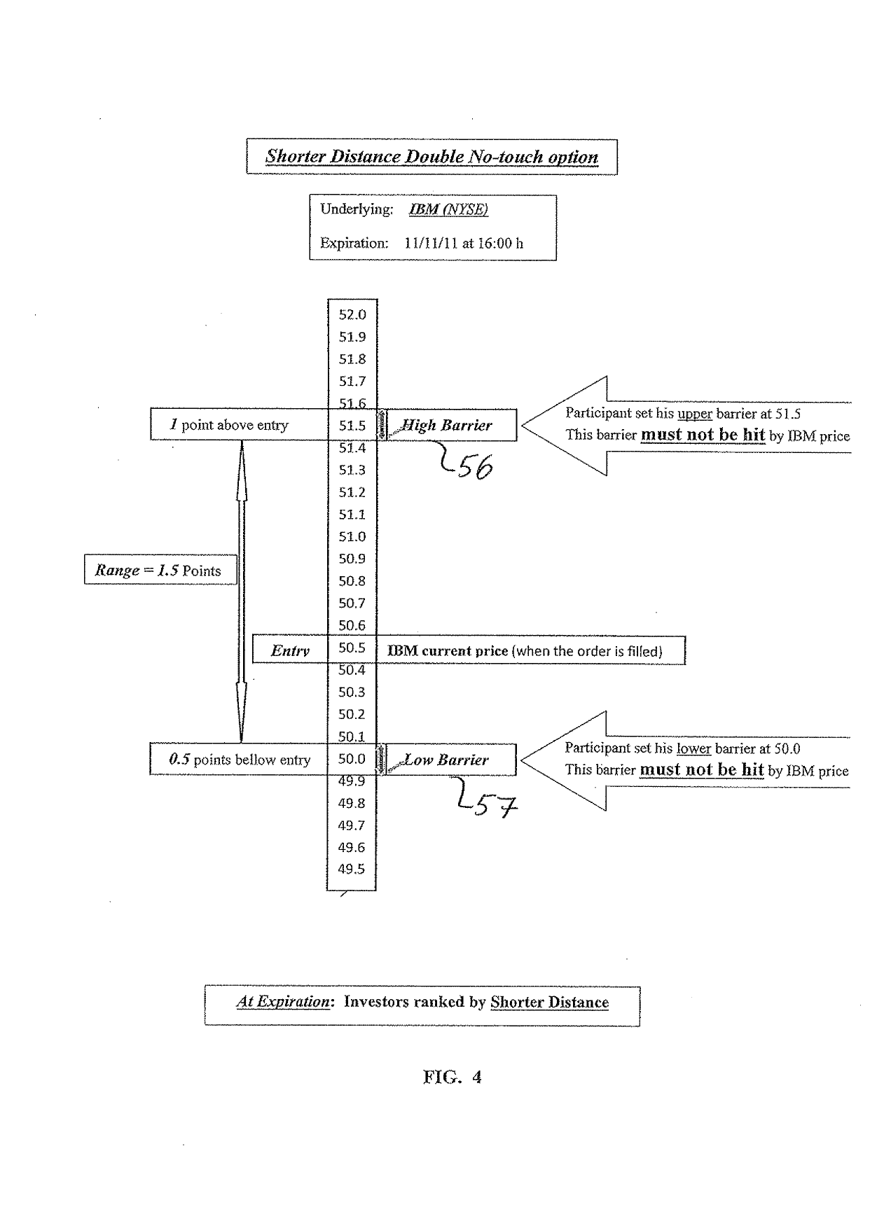

As seen from FIG. 4, the same rules, described above, apply, with the necessary changes, to another type of option for investors who predicts low volatility of the underlying:
1. Here the investor sets two Barriers on both sides of the Entry Price, that he predicts will not be Hit by the Underlying price.
2. If neither Barriers were Hit until Expiration, the option will be ranked by the distance in Points between the two Barriers. If one or both Barriers were hit, the option may be assigned a zero value.
3. The option with the shortest distance between the Barriers will be ranked first, followed by options with higher Distances. Options with zero value will be ranked last.
4. The investor can set in the initial order additional Barriers in any Direction. For the Rank, the system considers the two Barriers that were not hit, one above and one below the Entry, and that the distance between them is the shortest (i.e. the Barriers that will give the option the highest Rank)
5. The investor can change the Barriers position, if neither were hit, but only away from the Entry Price, in a way which increases the distance between the Barrier and the Entry price (and thus increases the distance between the high Barrier and the low Barrier).

In all variations, there is only one binary function—who wins a payout and who loses his investment. This is determined by whether the Barrier is hit and then by Distance ranking. In the touch variations the Barrier/s should be hit and longer Distance generates higher rank and in the no-touch variations the Barrier/s should not be hit and shorter Distance generates higher rank. In all variations, moreover, the buyer may be allowed to set additional barriers in the initial order, and may change the Barrier/s position at any time before expiration as long as they were not hit (In the touch variations the Barrier can be moved to any direction but without crossing the Entry price, while in the no-touch variations the Barrier can be moved only away from the Entry price (i.e. increasing the Distance between the Barrier and the Entry price).

TABLE 1
Ranking Chart (One-Touch Options)

| Ranking | User Name | Distance | Target Status | Payout |
|---|---|---|---|---|
| 1 | Emma | 6.5 | Hit | 200 |
| 2 | John | 6.2 | Hit | 200 |
| 3 | Madison | 4 | Hit | 200 |
| 4 | Lily | 3.5 | Hit | 200 |
| 5 | Steve | 3 | Hit | 200 |
| 6 | Michael | 2.5 | Hit | 0 |
| 7 | Grace | 2.3 | Hit | 0 |
| 8 | Benjamin | 5.4 | Not hit yet | 0 |
| 9 | Julia | 4 | Not hit yet | 0 |
| 10 | Dan | 3.7 | Not hit yet | 0 |

Table 1 represents a ranking chart of ten buyers who placed orders that were filled relating to One-Touch Options. The ranking chart may be displayed to buyers and prospective buyers of One-Touch Options. This chart may also include another column which identifies the barrier associated with the order (not shown). The horizontal payout line (which in this chart appears between the 5^{th} and 6^{th} ranking), may be in color (not shown), for example red. In this case, the payout line divides the participants/buyers in half (between ranking 5 and 6) and the winners may receive double their investment amount (assuming the payout is divided equally). The investor may change his barrier, if it was not hit, in order to increase his chances to be ranked above the red line. Alongside the display may appear a scenario calculator input, for example a button labeled “What If”, that when actuated calculates and displays the ranking under a scenario where the underlying security reaches a certain price and under the assumption where the barrier is a certain price.

A predefined percentage of the investors who have the highest ranking will divide amongst themselves the money invested by all the investors (so those investors below the payout line will lose their investment). The payout formula is as follows:
N—Number of options in the series
I—Investment per option
T—Percentage of options that can generate a payout
W—Maximum number of options that can generate a payout
R—Difference between W and the preceding integer (0<=R<1)
P—Payout to the top (W−R) options.
H—Number of options with hit barrier.

W=N*T

P (when W<=H)=(N*I)/(N*T)=I/T

P (when W>H)=(N*I)/H

If the number of options eligible for a payout (W) is bigger than its preceding integer by (R) and W<=H, then (W−R) of the options will generate the payout (P) and one option will generate a payout of R*P. If the number of options with hit barrier (H) is lower than W, then the payout increases. The lower H is, the higher the payout.

In the rare case of just one option in the series, the market operator is the one that will pay the payout if this option's barrier was hit.

Accordingly, the present invention may be described as a system. 10 or structure 10 for binary options. The binary option structure may be a touch option structure or system 10. System 10 may include a display structure 20 for displaying an entry price, which represents the underlying security current price, to prospective buyers. The display structure 20 may include a structure, such as in Table 1, for displaying to buyers and prospective buyers an updateable current ranking of the distances associated with buyers and/or with orders in a series. The updateable current ranking may include the final ranking. Display structure 20 may be viewed on a computer screen or on the screen of any digital device having a screen. In addition, display structure 20 may be operatively engaged to a digital processor which in turn may be in communication with a server accessible by buyers.

System 10 may include a digital processor 30 which may be programmed (using software or otherwise) to present binary option order selections, which may be touch option order selections, to buyers, the selections including underlying security, expiration date and investment amount. Digital processor 30 may store updated values of the entry price then current for the underlying security until the expiration date, “Expiration date”, may, in some embodiments, refer to a period of time or a point in time other than a calendar date and accordingly the term “expiration date” should be understood to include such an expiration period or point.

The digital processor 30 may record the buyer's selections of the underlying asset, the expiration date and the investment amount and group together into a series a plurality of touch option orders that match in underlying, expiration date and investment amount into a series. As shown in FIG. 1, for each buyer in the series that was created by the matching, digital processor 30 may record a buyer's selection of a barrier 55 for each touch option order in the series. The digital processor 30 or another digital processor may process the touch option orders of the series. Processing the touch option means implementing the order or communicating with a computer or person that implements the order instructions as to implementation of the order.

Digital processor 30 may calculate a rank for each order. Consequently, as shown in FIG. 1, for each order in the series, digital processor 30 may assign a zero value to orders whose barrier was not hit and, for buyers whose barrier 55 was hit, may calculate a distance between the entry price and the barrier of the order. In the case of the No-Touch Option structure shown in FIG. 2, for each order in the series, digital processor may instead assign a zero value to orders whose barrier 55 was hit and for buyers whose barrier 55 was not hit the digital processor 30 may calculate a distance between the entry price and the barrier 55 of the order, with a smaller distance associated with a higher rank. In both the touch option and the no-touch option structures of FIGS. 1-2, the entry price used for calculating the distance is capable of varying with the order and would be the entry price at a time that a buyer's order was filled.

The distance between a barrier 55 and the entry price (in any embodiment) may be measured either in absolute points or as a percentage price increase between the barrier (which is a price) and the entry price for the given order where the barrier is above the entry price and as a percentage decrease where the barrier is below the entry price. Comparisons between the percentage increase and percentage decrease may be made based on absolute value (for example a percentage increase of 10% counts as “10” and a percentage decrease of 10% counts as “10”).

The entry price used for calculating the distance may vary with the order since the entry price at a time that a buyer's order was filled is what counts. This is because different investors/buyers place orders at different times prior to the expiration date, (and they were filled at different times). It should be understood that “expiration date” could in some versions refer to an exact time within a day. Accordingly, digital processor 30 may also rank the distances of buyers associated with each order in the series.

Upon expiration of the touch option, digital processor 30 may divide the ranking into a winning part and a losing part and may calculate payouts to buyers in the winning part by dividing the total investment series, less any commissions, among the buyers in the winning part of the ranking. The payout line separates the winning part from the losing part of the ranking.

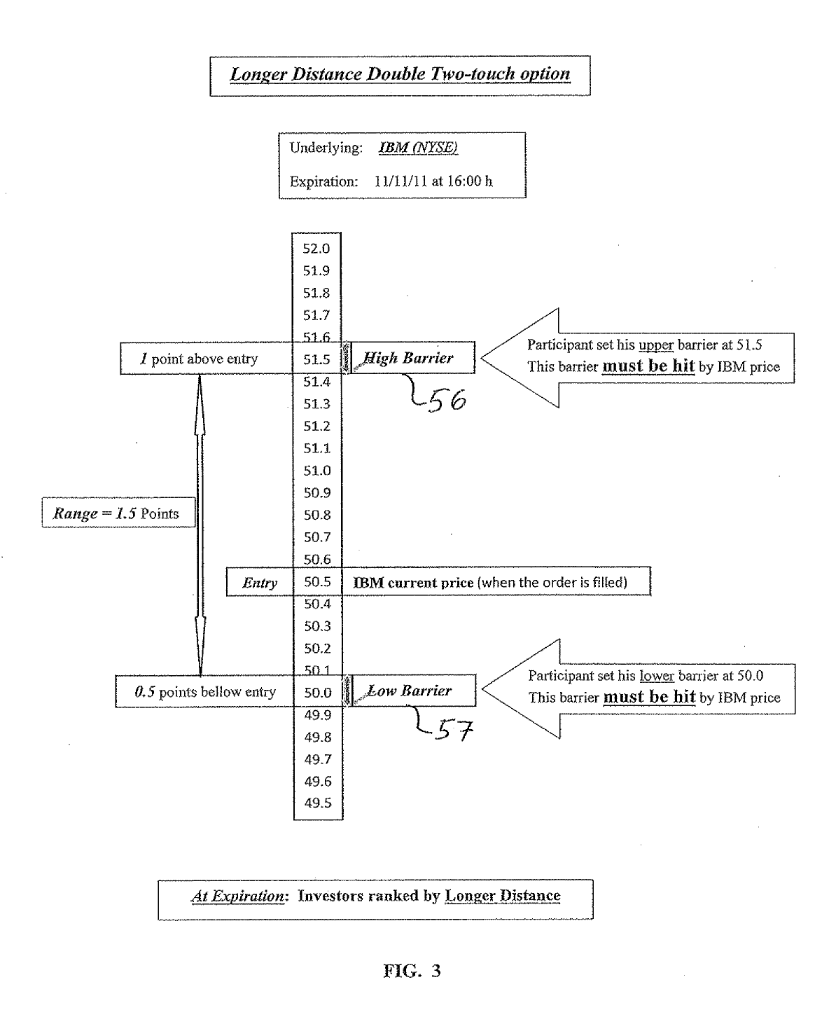

In the case of double touch options, as shown in FIG. 3 and FIG. 4, there are differences. For example, as shown in FIG. 3, digital processor 30 may receive a buyer's selection of a high barrier 56 above a buyer's entry price and a low barrier 57 below the buyer's entry price for each double touch option order in the series and process the double touch option orders of the series. In the case of Double Two-Touch Options shown in FIG. 3, the digital processor may be programmed, for each order in the series, to assign a zero value to orders in which at least one of the two barriers was not hit. For buyers whose both barriers were hit, the digital processor may be programmed to assign the distance between the high and low barriers 56, 57, with the longer distance between the barriers associated with a higher rank.

In FIG. 4, the Double No-Touch Option structure, the digital processor may be programmed to assign a zero value to orders in which at least one barrier was hit and for buyers whose barriers were not hit digital processor 30 may calculate the distance between the high barrier and the low barrier, wherein the smaller the distance, the higher the rank.

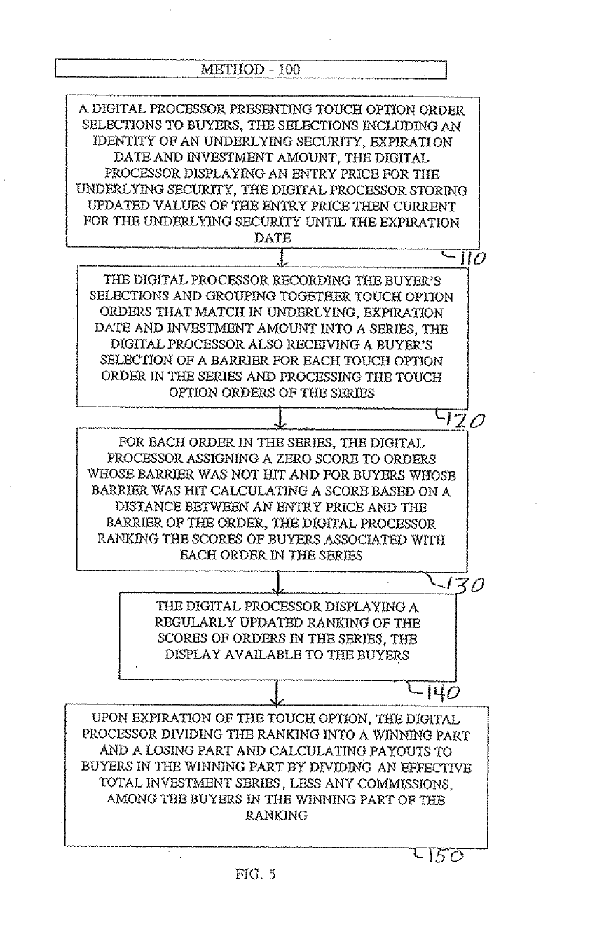

As seen from FIG. 5, the present invention may also be expressed as a method 100 of operating a binary option structure, which may be a touch option structure. Method 100 may comprise a step 110 of a digital processor presenting touch option order selections to buyers, the selections including underlying security/asset, expiration date and investment amount, the digital processor displaying an entry price representing the underlying security/asset current price, the digital processor storing updated values of the entry price then current for the underlying security/asset until the expiration date;

In step 120 of method 100, the digital processor may receive and record the buyer's selections and may group together touch option orders that match in underlying, expiration date and investment amount into a series. The digital processor may also receive a buyer's selection of a barrier for each touch option order in the series and may process the touch option orders of the series.

Method 100 may further include a step 130 whereby for each order in the series, the digital processor assigns a zero value to orders whose barrier was not hit and for buyers whose barrier was hit calculating a distance between an entry price and the barrier of the order. The digital processor may rank the distances of buyers associated with each order in the series and may assign a zero value to orders ranked last.

In step 140, a display structure or the digital processor may display a regularly updated ranking of the distances of orders in the series, an example of which is shown in Table 1. In one version, the display of the ranking is updated whenever there is a new order. In another version, it is updated whenever there is a change in ranking. In still another preferred version, the display is updated whenever there is a new price available for the underlying and the display structure may be in communication with a computer feeding it the constantly changing price of the underlying. The display may be made available to the buyers and in some versions to prospective buyers as well. In some versions, the ranking may be updated by the digital processor in real time.

In a further step 150 of method 100, upon expiration of the touch option, the digital processor may divide the ranking into a winning part and a losing part and calculate payouts to buyers in the winning part by dividing the total investment series, less any commissions, among the buyers in the winning part of the ranking. For example, the winning part may represent a top half of the ranks in the series and winning buyers receiving double their investment.

In some versions of method 100, buyers (investors) may be prompted to select what proportion of the ranking of a series is to be in the winning part and further grouping together buyers with similar responses. For example, in some versions a choice may be offered the investors whether they wish to be in a “contest” in which winners double their money and half the investors win or to be in a contest in which winners triple their investment but where only one third the investors win. Many variations can be devised this way. Note that the touch option structure of the present invention may be designed to pay out based on a relative performance of the participants rather than on an absolute performance of the participants. Accordingly, an investor may be very confident of his ability to succeed relative to others in a contest and may therefore choose the having a higher payout multiple with a lower absolute percentage of winners.

In the One-Touch Option, the Double Two-Touch Option, the No-Touch Option and the Double No-Touch option, buyers, after an order is filled, may be allowed, in response to viewing the digital processor's displaying of the ranking, to move a barrier that has not been hit prior to expiration without moving the barrier to an opposite side of an entry price (in the case of the No-Touch Option and the Double No-Touch option the bather can be moved only to away from the entry price).

In the One-Touch Option, the Double Two-Touch Option, the No-Touch Option and the Double No-Touch Option, buyers may be allowed to select multiple barriers with an initial order. In that case, the digital processor may consider in the ranking only the barrier amongst the multiple barriers that generates the higher rank.

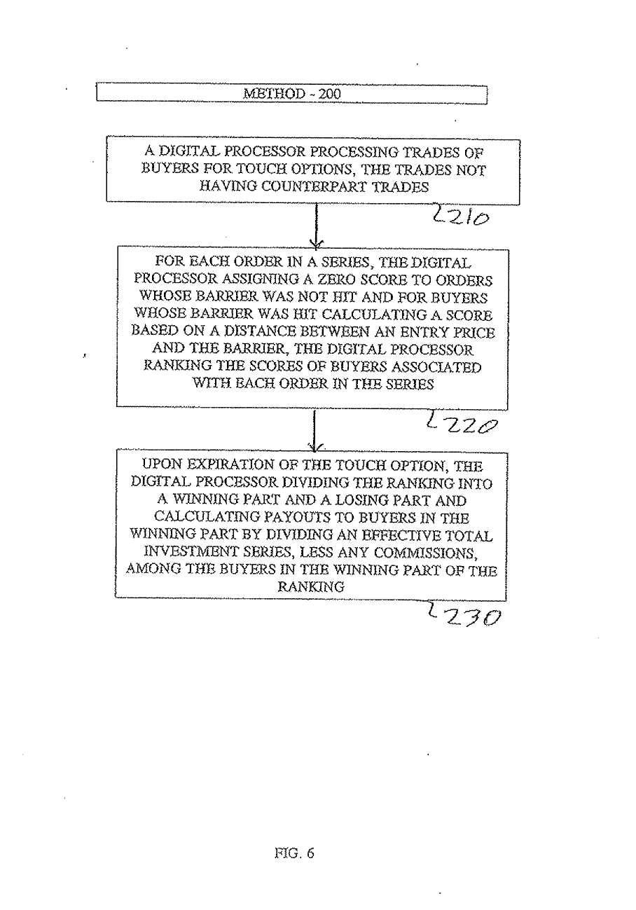

As shown in FIG. 6, the present invention may also be expressed as a method 200 of operating a touch option structure. Step 210 of method 200 may involve a digital processor processing trades of buyers for touch options, the trades not having counterpart trades. Method 200 may involve a step 220 that for each order in a series, the digital processor assigns a zero value to orders whose barrier was not hit and for buyers whose barrier was hit may calculate a distance between an entry price and the barrier. The digital processor may rank the distances of buyers associated with each order in the series and may assign a zero value to orders ranked last which may make them disqualified for winning. In step 230, upon expiration of the touch option, the digital processor may divide the ranking into a winning part and a losing part and calculate payouts to buyers in the winning part by dividing the total investment series among the buyers in the winning part of the ranking.

In some versions of method 200, there may be a step of breaking tie ranks obtained when the distance between the entry price and the barrier is measured in points by considering the distance in percentage terms. In other versions, there may be a further step of, regarding remaining tie ranks that remain after considering the distance in percentage terms, breaking the remaining tie ranks by determining which order had the shorter position held time (in the case of no-touch and double no-touch options, longer position held time is better). In other versions, there may be a further step, regarding remaining tie ranks that remain after considering the position held time, breaking the remaining tie ranks by determining which option buying order was filled earlier.

In another embodiment, the structure of the “Longer Distance Option” with one barrier is used for an option on the closing price of the underlying at expiration. This is called a European binary option (“touch option” is an American binary option). The underlying closing price, i.e. its price at expiration, needs to be above the barrier in cases where the barrier is above the entry price and needs to be below the barrier in cases where the barrier is below the entry price. The option with the longest distance between the barrier and the entry price will be ranked first. If the underlying price did not close at expiration above/below the barrier when the barrier is above/below the entry price (i.e. the closing price did not reach the barrier), the option will get a zero value and be ranked last. The investor cannot change the position of a barrier, but it is possible to set more than one barrier in the initial order and the option will be ranked by the barrier that generated the highest rank.

In another embodiment, the structure of the “Shorter Distance Option” with one barrier is used for an option on the closing price of the underlying at expiration (This is a European binary option). The underlying closing price, i.e. its price at expiration, needs to be below the is barrier in cases where the barrier is above the entry price and needs to be above the bather in cases where the barrier is below the entry price. The option with the shortest distance between the barrier and the entry price will be ranked first. If the underlying price closed at expiration above/below the barrier when the barrier is above/below the entry price (i.e. the closing price reached the barrier), the option will get a zero value and be ranked last. The investor cannot change the position of a barrier, but it is possible to set more than one barrier in the initial order and the option will be ranked by the barrier that generated the highest rank.

In the touch options structures described above, the digital processor 30 may be programmed to assign a zero value to participants who did not hit the barrier (One-Touch), or who hit the barrier (No-Touch) or who did not hit both barriers (Double Two-Touch) or who hit at least one barrier (Double No-Touch). Although “zero value” may literally mean an actual value of zero, more generally it may also mean a value designed to place that participant in a last place in the ranking or in a group of last places in the ranking. In the claims, the latter definition should be understood unless the phrase “actual zero value” is used. Accordingly, although in the payout formula above zero value was referring to actual zero value, this is merely a non-limiting example. In other versions, the losers below the payout line may receive a non-zero value which is less than what the winners receive. In preferred embodiments, participants ranked last (below the Payout Line) are disqualified from winning and receive no portion of the Total Series Investment. In other embodiments, such participants may be disqualified from winning but may receive a rebate that is lower than the value received by winning participants In this case, the total investment series is reduced by such rebate(s) to yield the effective Total Investment Series.

Disqualified from winning—in a preferred embodiment means disqualified from winning anything of the Total Series Investment In other embodiments it means disqualified from winning anything but a zero value of the Total Series Investment.

Although the above invention has been described in terms of an underlying that is a security, such as equity security (e.g. common stock of a corporation), debt security or derivative contracts, it is contemplated by the present invention that the underlying could be another kind of asset that has a fluctuating market price. Non-limiting examples include spot prices of foreign exchange, a precious metal or other commodity, an index or indices, or a parcel of real estate.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of operating a touch option structure, comprising:
a digital processor presenting touch option order selections to buyers, the selections including an identity of an underlying security, expiration date and investment amount, the digital processor displaying an entry price representing the underlying security current price, the digital processor storing updated values of the entry price then current for the underlying security until the expiration date;
the digital processor recording the buyer's selections and grouping together touch option orders that match in underlying, expiration date and investment amount into a series, the digital processor also receiving a buyer's selection of a barrier for each touch option order in the series and processing the touch option orders of the series;
for each order in the series, the digital processor assigning a zero value to orders whose barrier was not hit and for buyers whose barrier was hit calculating a distance between an entry price and the barrier of the order, the digital processor ranking the distances of buyers associated with each order in the series, zero value orders ranked last;
the digital processor displaying a regularly updated ranking of the orders in the series, the display available to the buyers and
upon expiration of the touch option, the digital processor dividing the ranking into a winning part and a losing part and calculating payouts to buyers in the winning part by dividing an effective total investment series, less any commissions charged, among the buyers in the winning part of the ranking.

2. The method of claim 1, further comprising prompting buyers to select what proportion of the ranking of a series is to be in the winning part and further grouping together buyers with similar responses.

3. The method of claim 1, further comprising allowing buyers, after an order is filled and in response to viewing the digital processor's displaying of the ranking, to move a barrier prior to expiration without moving the barrier to an opposite side of an entry price.

4. The method of claim 1, further comprising allowing buyers, after an order is filled, to move a barrier prior to expiration without moving the barrier to an opposite side of an entry price.

5. The method of claim 1, further comprising allowing buyers to select multiple barriers with an initial order and further comprising considering in the ranking only the barrier amongst the multiple barriers that generates the higher rank.

6. A method of operating a touch option structure, comprising:
a digital processor processing trades of buyers for touch options, the trades not having counterpart trades;
for each order in a series, the digital processor assigning a zero value to orders whose barrier was not hit and for buyers whose barrier was hit calculating a distance between an entry price and the barrier, the digital processor ranking the distances of buyers associated with each order in the series, zero value orders ranked last; and
upon expiration of the touch option, the digital processor dividing the ranking into a winning part and a losing part and calculating payouts to buyers in the winning part by dividing an effective total investment series, less any commissions charged, among the buyers in the winning part of the ranking.

7. The method of claim 6, further comprising the winning part representing a top half of the ranks in the series and comprising winning buyers receiving double their investment.

8. The method of claim 6, further including breaking tie ranks obtained when the distance between the entry price and the barrier is measured in points by considering the distance in percentage terms

9. The method of claim 8, further comprising regarding remaining tie ranks that remain after considering the distance in percentage terms breaking the remaining tie ranks by determining which order had the shorter position held time, or in the case of no-touch and double no-touch options, which order had the longer position held time.

10. The method of claim 9, wherein if a tie still exists, the earliest the order was filled is considered to break the tie.

11. A system for binary options, comprising:
a display structure for displaying an entry price representing the underlying security current price, to prospective buyers, the display structure also including structure for displaying to buyers and prospective buyers an updateable current ranking of the distances associated with orders in a series; and
a digital processor programmed to
store updated values of the entry price then current for the underlying security until the expiration date,
record each buyer's selections of an underlying, an expiration date and an investment amount and group together into a series a plurality of binary option orders that match in underlying, expiration date and investment amount,
for each buyer in the series, record the buyer's selection of a barrier for each binary option order in the series and process the binary option orders of the series,
for each order in the series, assign a zero value to orders whose barrier was not hit and for buyers whose barrier was hit calculate a distance between an entry price and the barrier of the order with a greater distance associated with a higher rank, the entry price varying with the order and being the entry price at a time that a buyer's order was filled,
rank the distances of buyers associated with each order in the series, zero value orders ranked last, and
upon expiration of the binary option, divide the ranking into a winning part and a losing part and calculate payouts to buyers in the winning part by dividing an effective total investment series, less any commissions charged, among the buyers in the winning part of the ranking.

12. The system of claim 11, further comprising the distance between the entry price and the barrier measured in absolute points.

13. The system of claim 11, further comprising the distance between entry price and the barrier for a given order measured as a percentage increase between the barrier and the entry price for the given order where the barrier is above the entry price and as a percentage decrease where the barrier is below the entry price, comparisons between the percentage increase and percentage decrease being made based on absolute value.

14. The system of claim 11, wherein the barrier is movable by the buyer after the buyer's initial order is filled as long as the barrier has not been hit.

15. The system of claim 14, wherein, the barrier is not movable across the entry price.

16. The system of claim 11, wherein the buyer can set additional barriers at a time of purchase of the option.

17. The system of claim 11, wherein the orders include conditional orders.

18. A system for double no-touch options, comprising:
a display structure for displaying an entry price representing the underlying security current price, to prospective buyers, the display structure also including structure for displaying to buyers an updateable current ranking of the distances associated with orders in a series; and
a digital processor programmed to
store updated values of the entry price then current for the underlying security until the expiration date,
record the buyer's selections of the underlying, the expiration date and the investment amount and group together in a series double no-touch option orders that match in underlying, expiration date and investment amount,
record a buyer's selection of a high barrier above a buyer's entry price and a low barrier below the buyer's entry price for each double no-touch option order in the series and process the double no-touch option orders of the series,
for each order in the series, assign a zero value to orders in which at least one barrier was hit and for buyers whose barriers were not hit calculate a distance between the high barrier and the low barrier,
rank the distances of buyers associated with each order in the series wherein the smaller the distance, the higher the rank, zero value orders ranked last, and
upon expiration of the double no-touch option, divide the ranking into a winning part and a losing part and calculate payouts to buyers in the winning part by dividing an effective total investment series, less any commissions charged, among the buyers in the winning part of the ranking.

19. The system of claim 18, further comprising the current updateable ranking including the winning ranking.

20. The system of claim 18, wherein at a time of purchase of the option the buyer can set additional barriers on one or both sides of the entry price.

21. The system of claim 18, wherein, after the buyer's order is filled, the barriers, which were not been hit yet, are movable by the buyer so as to increase the distance between the barriers.

22. The system of claim 18, wherein the orders include conditional orders.

23. A system for double two-touch options, comprising:
a display structure for displaying an entry price, which reflects the underlying security current price, to prospective buyers, the display structure also including structure for displaying to buyers and prospective buyers an updateable current ranking of the distances associated with orders in a series; and
a digital processor programmed to
store updated values of the entry price then current for the underlying security until the expiration date,
record the buyer's selections of the underlying, the expiration date and the investment amount and group together in a series double two-touch option orders that match in underlying, expiration date and investment amount,
record a buyer's selection of a high barrier above a buyer's entry price and a low barrier below the buyer's entry price for each double two-touch option order in the series and process the double two-touch option orders of the series,
for each order in the series, assign a zero value to orders in which at least one barrier was not hit and for buyers whose barriers were hit calculate a distance between the high barrier and the low barrier,
rank the distances of buyers associated with each order in the series wherein the higher the distance, the higher the rank, zero value orders ranked last, and
upon expiration of the double two-touch option, divide the ranking into a winning part and a losing part and calculate payouts to buyers in the winning part by dividing an effective total investment series, less any commissions charged, among the buyers in the winning part of the ranking.

24. The system of claim 23, wherein at a time of purchase of the option the buyer can set additional bathers on one or both sides of the entry price.

25. The system of claim 23, wherein, after the buyer's order is filled, the barriers, which were not been hit yet, are movable by the buyer but not across the entry price.

26. A system for no-touch options, comprising:
a display structure for displaying an entry price, representing the underlying security current price, to prospective buyers, the display structure also including structure for displaying to buyers and prospective buyers an updateable current ranking of the distances associated with orders in a series; and
a digital processor programmed to
store updated values of the entry price then current for the underlying security until the expiration date,
record each buyer's selections of an underlying, an expiration date and an investment amount and group together into a series a plurality of no-touch option orders that match in underlying, expiration date and investment amount,
for each buyer in the series, record the buyer's selection of a barrier for each no-touch option order in the series and process the no-touch option orders of the series,
for each order in the series, assign a zero value to orders whose barrier was hit and for buyers whose barrier was not hit calculate a distance between an entry price and the barrier of the order with a smaller distance associated a higher rank, the entry price used for calculating the rank capable of varying with the order and being the entry price at a time that a buyer's order is filled,
rank the distances of buyers associated with each order in the series, zero value orders ranked last, and
upon expiration of the touch option, divide the ranking into a winning part and a losing part and calculate payouts to buyers in the winning part by dividing an effective total investment series; less any commissions charged, among the buyers in the winning part of the ranking.

27. The system of claim 26, wherein at a time of purchase of the option the buyer can set additional barriers on one or both sides of the entry price.

28. The system of claim 26, wherein the barrier is movable by the buyer after the buyer's order is filled so as to increase the distance between the barrier and the entry price, so long as the barrier has not been hit.

29. A system of touch options trading in which trades do not have counterpart trades, the system comprising:
a display structure for displaying an entry price, representing the underlying security current price, to prospective buyers, the display structure also including structure for displaying to buyers and prospective buyers an updateable current ranking of the distances associated with orders in a series; and
a digital processor programmed to
store updated values of the entry price then current for the underlying security until the expiration date,
record the buyer's selections of the underlying, the expiration date and the investment amount and group together touch option orders that match in underlying, expiration date and investment amount into a series,
for each touch option order in the series, record a buyer's selection of a barrier and process the touch option orders of the series, for each order in the series, assign a zero value to orders whose barrier was not hit and for buyers whose barrier was hit calculate a distance between an entry price and the barrier of the order, the entry price capable of varying with the order and being the entry price at a time that a buyer's order is filled,
rank the distances of buyers associated with each order in the series, zero value orders ranked last, and
upon expiration of the touch option, divide the ranking into a winning part and a losing part and calculate payouts to buyers in the winning part by dividing an effective total investment series, less any commissions charged, among the buyers in the winning part of the ranking.

30. A system for European binary options, comprising:
a display structure for displaying an entry price, which reflects the underlying security current price, to prospective buyers, the display structure also including structure for displaying to buyers an updateable current ranking of the distances associated with orders in a series; and
a digital processor programmed to
store updated values of the entry price then current for the underlying security until the expiration date,
record each buyer's selections of an underlying, an expiration date and an investment amount and group together into a series a plurality of European binary option orders that match in underlying, expiration date and investment amount,
for each buyer in the series, record the buyer's selection of a barrier for each European binary option order in the series and process the European binary option orders of the series,
for each order in the series, assign a zero value to orders whose barrier was not reached by the closing price at expiration and for buyers whose barrier was reached by the closing price at expiration calculate a distance between an entry price and the barrier of the order with a greater distance associated with a higher rank, the entry price varying with the order and being the entry price at a time that a buyer's order was filled, and
upon expiration of the European binary option, rank the distances of buyers associated with each order in the series, zero value orders ranked last,
divide the ranking into a winning part and a losing part and calculate payouts to buyers in the winning part by dividing an effective total investment series, less any commissions charged, among the buyers in the winning part of the ranking.

31. The system of claim 30, wherein at a time of purchase of the option the buyer can select additional barriers on one or both sides of the entry price and the barrier that generates the highest rank is the one to be considered.

32. A system for European binary options, comprising:
a display structure for displaying an entry price, representing the underlying security current price, to prospective buyers, the display structure also including structure for displaying to buyers and prospective buyers an updateable current ranking of the distances associated with orders in a series; and
a digital processor programmed to
store updated values of the entry price then current for the underlying security until the expiration date,
record each buyer's selections of an underlying, an expiration date and an investment amount and group together into a series a plurality of European binary option orders that match in underlying, expiration date and investment amount,
for each buyer in the series, record the buyer's selection of a barrier for each European binary option order in the series and process the European binary option orders of the series,
for each order in the series, assign a zero value to orders whose barrier was reached by the closing price at expiration and for buyers whose barrier was not reached by the closing price at expiration calculate a distance between an entry price and the barrier of the order with a smaller distance associated a higher rank, the entry price used for calculating the rank capable of varying with the order and being the entry price at a time that a buyer's order is filled,
upon expiration of the European binary option, rank the distances of buyers associated with each order in the series, zero value orders ranked last,
divide the ranking into a winning part and a losing part and calculate payouts to buyers in the winning part by dividing an effective total investment series, less any commissions charged, among the buyers in the winning part of the ranking.
